(19) United States
(12) Patent Application Publication
(10) Pub. No.: US 2025/0024327 A1
(43) Pub. Date: Jan. 16, 2025

(54) QUEUEING DISCIPLINE MECHANISMS OF MLO-MAC FOR MULTI-LINK DEVICES

(71) Applicant: Samsung Electronics Co., Ltd., Suwon-si (KR)

(72) Inventors: Kyeong Jin Kim, Plano, TX (US); Abhishek Sehgal, Plano, TX (US); Bilal Sadiq, Plano, TX (US); Yuming Zhu, Plano, TX (US)

(21) Appl. No.: 18/755,563

(22) Filed: Jun. 26, 2024

Related U.S. Application Data
(60) Provisional application No. 63/525,907, filed on Jul. 10, 2023.

(51) Int. Cl. H04W 28/08

(52) U.S. Cl. CPC H04W 28/0975; H04W 28/0925

(57) ABSTRACT

A method performed by an apparatus capable of multi-link operations with respect to a plurality of channels, comprising determining a fast channel and a slower channel, transmitting a packet in a packet queue using the fast channel without using the slower channel when a number of data packets waiting in the packet queue is smaller than a first threshold number, and transmitting a packet in the packet queue using both the fast channel and the slower channel when the number of data packets waiting in the packet queue is equal to or greater than the first threshold number.

### CROSS-REFERENCE TO RELATED APPLICATIONS

This application claims the benefit of priority from U.S. Provisional Application No. 63/525,907 entitled “Queueing Discipline Mechanisms of MLO-MAC for Multi-Link Device” filed Jul. 10, 2023, which is incorporated herein by reference in its entirety.

### TECHNICAL FIELD

This disclosure relates generally to a wireless communication system, and more particularly to, for example, but not limited to, queueing discipline mechanisms of multi-link operation (MLO) in the medium access control (MAC) layer for multi-link devices.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides method performed by an apparatus capable of multi-link operations with respect to a plurality of channels. The method comprises determining a fast channel and a slower channel. The method comprises transmitting a packet in a packet queue using the fast channel without using the slower channel when a number of data packets waiting in the packet queue is smaller than a first threshold number. The method comprises transmitting a packet in the packet queue using both the fast channel and the slower channel when the number of data packets waiting in the packet queue is equal to or greater than the first threshold number.

In some embodiments, the first threshold number is determined based on a latency in a scheme that uses the fast channel and the slower channel and a power consumption in the scheme that uses the fast channel and the slower channel.

In some embodiments, the first threshold number is determined based on a rate at which packets arrive in the packet queue.

In some embodiments, the first threshold number is determined further based on services rates of the fast channel and the slower channel.

In some embodiments, if the rate at which packets arrive in the packet queue increases, the threshold is increased.

In some embodiments, the method further comprises turning off the slower channel when a queue associated with the slower channel is empty and a queue associated with the fast channel drops below a second threshold number, the second threshold number being the same as or different than the first threshold number.

In some embodiments, the method further comprises turning off the slower channel when a predetermined time passes.

One aspect of the present disclosure provides a station (STA) in a wireless network. The STA comprises a memory and a processor coupled to the memory. The processor is configured to establish multi-link operation with respect to a plurality of channels including a fast channel and a slower channel. The processor is configured to transmit a packet in a packet queue using the fast channel without using the slower channel when a number of data packets waiting in the packet queue is smaller than a first threshold number. The processor is configured to transmit a packet in the packet queue using both the fast channel and the slower channel when the number of data packets waiting in the packet queue is equal to or greater than the first threshold number.

In some embodiments, the first threshold number is determined based on a latency in a scheme that uses the fast channel and the slower channel and a power consumption in the scheme that uses the fast channel and the slower channel.

In some embodiments, the first threshold number is determined based on a rate at which packets arrive in the packet queue.

In some embodiments, the first threshold number is determined further based on services rates of the fast channel and the slower channel.

In some embodiments, if the rate at which packets arrive in the packet queue increases, the threshold is increased.

In some embodiments, the processor is further configured to turn off the slower channel when a queue associated with the slower channel is empty and a queue associated with the fast channel drops below a second threshold number, the second threshold number being the same as or different than the first threshold number.

In some embodiments, the processor is further configured to turn off the slower channel when a predetermined time passes.

One aspect of the present disclosure provides a method performed by an apparatus capable of multi-link operations with respect to a plurality of channels. The method comprises determining a fast channel and a slower channel. The method comprises, when the fast channel and slower channel are idle, selecting one of the fast channels and the slower channel for transmissions based on a probability. The method comprises when the slower channel is idle and the fast channel is busy, selecting the slower channel for transmissions. The method comprises transmitting a data packet using the selected channel.

In some embodiments, when one of the fast channels and the slower channel finishes a transmission, selecting the finished channel, for a data packet waiting at the head of a packet queue.

In some embodiments, an arriving packet waits in a packet queue when both the fast channel and the slower channel are busy.

In some embodiments, the probability is determined based on a latency in a first scheme that uses the fast channel and the slower channel and a power consumption in the first scheme that uses the fast channel and the slower channel.

In some embodiments, the probability is determined further based on a latency in a second scheme that does not use the slower channel and uses the fast channel and a power consumption in the second scheme.

In some embodiments, the latency in the first scheme is determined based on a collision probability, a minimum contention window, a CCA busy time, and a transmit opportunity (TXOP) duration in the first scheme.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a distributed coordination function (DCF) in accordance with an embodiment.

FIG. 5 illustrates Enhanced Distributed Channel Access (EDCA) in accordance with an embodiment.

FIG. 6 illustrates a table with mappings for incoming frame with a different priority into an access category (AC) in accordance with an embodiment.

FIG. 7 illustrates a block diagram of MLD-MAC with MLO and DCF in accordance with an embodiment.

FIG. 8 illustrates an example of an optimal K depending on the arrival rate in accordance with an embodiment.

FIG. 9 illustrates static split discipline applied to MLO comprising two channels in accordance with an embodiment.

FIG. 10 illustrates an example of MLO control state diagram in accordance with an embodiment.

FIG. 11 illustrates a flow chart of an example process of configuring MLO using a load threshold in accordance with an embodiment.

FIG. 12 illustrates a flow chart of an example process of configuring MLO using a packet threshold in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

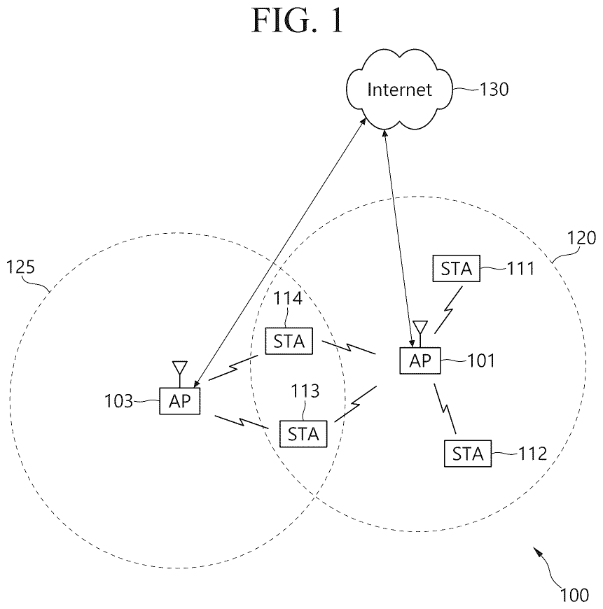

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

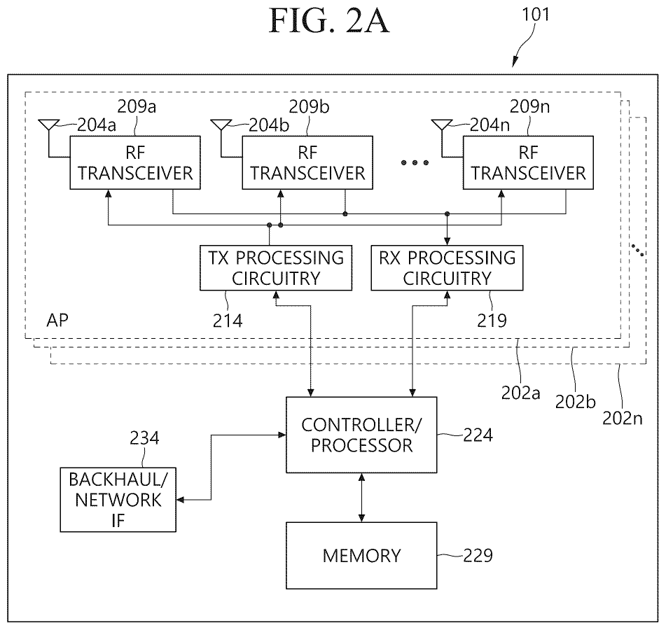

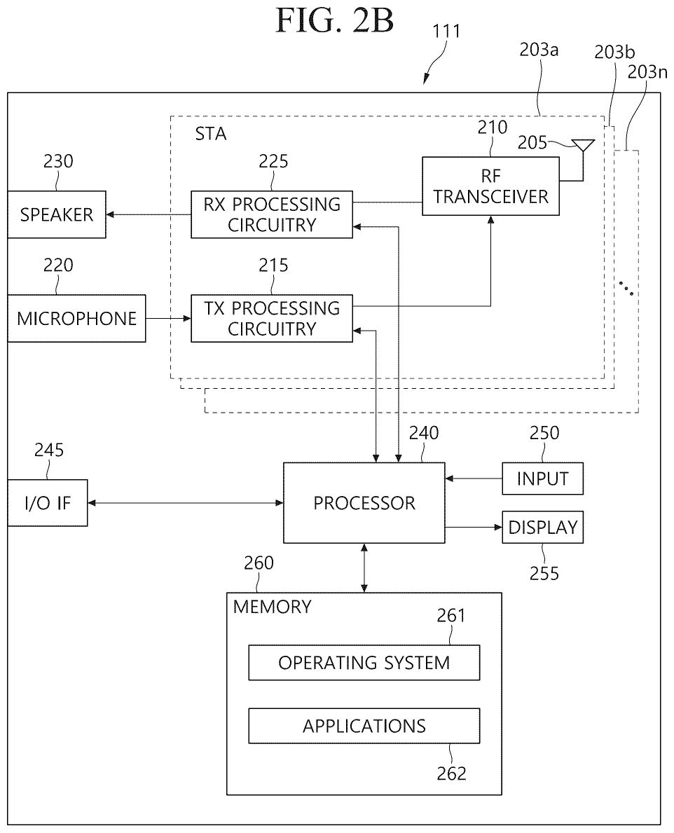

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

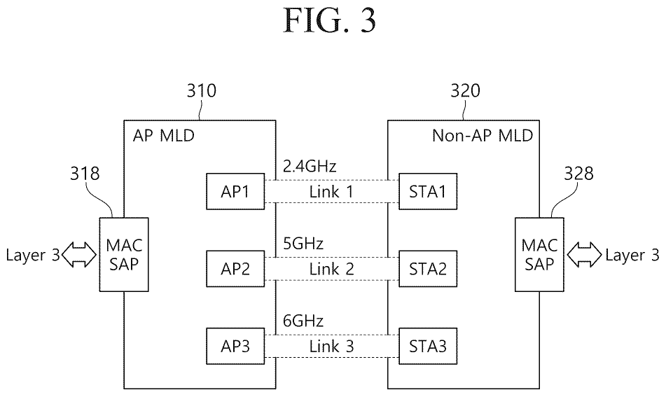

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

Multi-link operation (MLO) in the media access control (MAC) layer may enable the joint use of multiple radio interfaces on a single device through a single association, which is a concept of a multi-link device (MLD). Each independent radio interface is associated with its dedicated physical (PHY) and sub-MAC protocol that performs channel access, transmits, and receives data packets. In addition, the MLD has a unique MLO-MAC address and a packet queue, where the packet queue is shared by the available transmission channels or links.

When MLO is accomplished by the MLD over multiple frequency bands such as 2.4 GHz, 5 GHz, and 6 GHz, simultaneously, the MLO-MAC may enable the MLD to improve throughput, reduce latency, increase reliability, and may make it possible to develop a flexible channel switching without negotiation. In particular, since MLO may enable the MLD to establish multiple links via available multiple channels, each of which performs independent channel access, the latency caused by contending stations can be reduced. Thus, by efficiently using the available spectrum, the MLO-MAC may be beneficial to applications such as video and audio calls, and on-line gaming that may not require an extremely high data rate but a guaranteed low latency. When the MLD is composed of multiple stations that operate in the same frequency band, it may be recognized as the MLD with multiple radios.

As an MLD may use different frequency bands for transmissions and receptions, it may be assumed that the MLD supports an asynchronous simultaneous transmission and reception (STR). Although cross-channel interference may be an intrinsic problem for the use of MLO, its impact on MLO can be negligible under a relatively sufficient spectral distance.

In some embodiments, since MLO is a feature of the MLO-MAC for delay constrained and high-throughput requiring applications, MAC may benefit from control and training mechanisms of the packet queue to ensure that the MLD finishes its delay constrained transmissions and receptions within the worst-case delay constraint. Furthermore, MLO may establish and access multiple channels in the high frequency bands simultaneously, resulting in more power consumption than the legacy type devices, which may be critical for mobile devices.

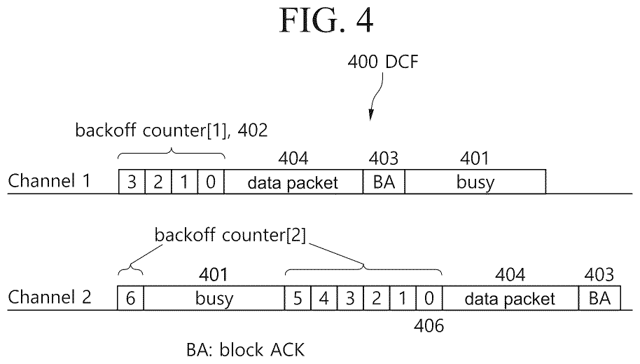

Hereinafter, a distributed coordination functions (DCF) in accordance with an embodiment will be described with reference to FIG. 4.

FIG. 4 illustrates a distributed coordination function (DCF) in accordance with an embodiment. As a MAC, the IEEE 802.11 standard specifies a mandatory distributed coordination functions (DCF), 400. For packet transmissions, DCF may be incorporated with a one-way handshaking, which may be referred to as the basic access. When the channel is sensed busy, 401, a station may need to defer to its transmissions according to a backoff algorithm. A backoff counter, 402, may be chosen randomly in the interval [0,CW], where CW is the contention window size. The backoff counter, 402, may decrease when the channel is sensed idle. The backoff counter, 402, may stop decreasing when the channel is sensed busy, 401, by the transmissions by other stations or collisions with other stations, 401. When the backoff counter, 402, of the target station reaches zero, it can transmit a packet, 404, and the destination responds by sending ACK or block ACK (BA), 403, after a specific period of time for successful receptions. However, when the packet is received unsuccessfully, CW may be doubled up to the CWmax within the maximum number of retransmissions, K.

In some embodiments, with respect to MAC layer contentions, eventually the latency may increase exponentially as the number of stations increases. All affiliated stations in the set of available frequency bands of the MLD may be assumed to use the DCF or its extended version. However, DCF may not be able to differentiate the transmission opportunity with a predetermined priority.

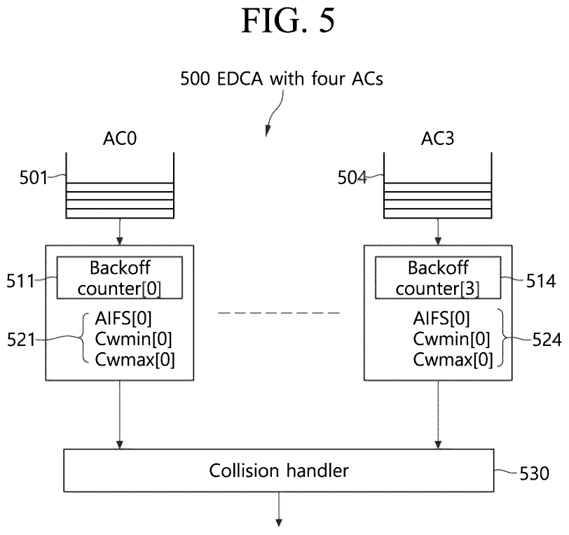

Hereinafter, Enhanced Distributed Channel Access (EDCA) in accordance with an embodiment will be described with reference to FIG. 5.

FIG. 5 illustrates Enhanced Distributed Channel Access (EDCA) in accordance with an embodiment. The EDCA, 500, may provide a differentiated channel access at each station to the frames of different priorities represented by the higher layer. With the EDCA, a single MAC for the station can have multiple queues, 501 and 504, with each of which may operate independently with an individual priority. Frames with different priorities may be transmitted via different contention window parameters, such as contention window size among others. Using the EDCA, the station cannot send a frame beyond the transmit opportunity (TXOP) limit by the EDCA, where TXOP is the time duration for which a station can send frames after it has gained contention. When a frame is too large to fit into within a single TXOP, it may be fragmented into multiple frames.

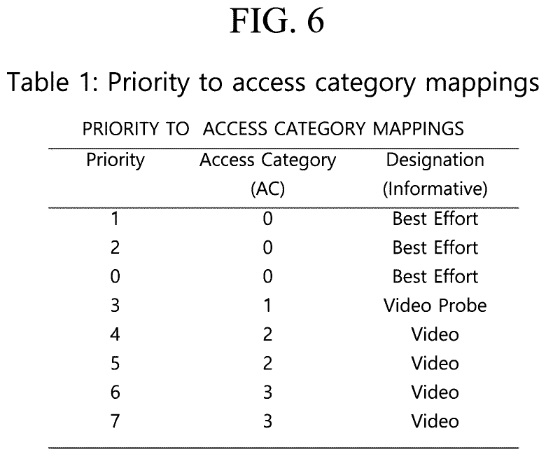

For example, an IEEE 802.11e supporting station may implement four access categories (ACs), 500, AC0, . . . , AC3. Each incoming frame with a different priority may be mapped into an AC at the MAC as summarized in Table 1 illustrated in FIG. 6 in accordance with an embodiment. Due to four classes of AC, the 802.11e MAC can be modeled to be equipped with four transmission queues, 501 and 504, with each of which operates as a single DCF. Each queue may have its own interframe space (IFS), called the Arbitration IFS (AIFS), 521 and 524, and backoff counter, 511 and 514. In contrast to DCF, 400, of FIG. 4, which uses a common DCF Interframe Space (DIFS), CWmin, a minimum value of CW, CWmax, a maximum value of CW, each AC specifies their values, e.g., AIFS[AC], CWmin[AC], and CWmax[AC], 521 and 524.

In some embodiments, the EDCA may be beneficial to prioritize the voice and video traffic over more elastic data traffic. In general, by assigning smaller values of AIFS and CWmin for the voice and video traffic, a greater channel occupancy can be achieved. However, the probability of collisions may increase due to use of a smaller CWmin.

The backoff counter of each AC, 511 and 514, may be chosen from [1,1+CW[AC]], where CW[AC] is the contention window size for a particular AC. The AP may determine and exchange the limit of the EDCA TXOP for each AC, e.g., TXOPlimit[AC], within which a STA can transmit multiple data packets being assigned with the same AC. When more than one AC finishes counting down the backoff counters, 511 and 514, to zero at the same time, the collision occurred among ACs may be handled by the collision handler, 530.

Hereinafter, latency metrics will be described in accordance with several embodiments.

In some embodiments, when all active stations have a packet for transmission, and the number of active stations in the network is known, the latency may be defined as the time difference between the departure time of a packet from the queue and the packet reception time at the destination. However, in general, the number of active stations in the network may be unknown.

Hereinafter, mean latency of DCF will be described in accordance with several embodiments.

In some embodiments, under a network setup where the number of active stations in the network is unknown while these active stations have a packet for transmission, a mean latency metric may be defined, E[T], as in Equations 1 and 2.

$$E [ T ] = \frac{1 - p}{1 - {p}^{K + 1}} {\sum }_{k = 0}^{K} {p}^{k} ( \text{} {T}_{s} + {kT}_{c} + \frac{{T}_{s l o t} {CW}_{min}}{2} ( {2}^{k + 1} - 1 ) + TXop ( \frac{1}{1 - \frac{Tcca}{T r o}} - 1 ) ) , \qquad Equation l$$

$$E [ T ] \approx {T}_{s} + \frac{p}{( 1 - p )} {T}_{c} + \frac{{T}_{slot} {CW}_{min}}{2 ( 1 - {p}^{K + 1} ) ( 1 - 2 p )} ( 1 - 64 {p}^{6} ) + ( \frac{{T}_{C C A}}{{T}_{r o} - {T}_{C C A}} ) , \qquad Equation 2$$

In Equations 1 and 2, K is the maximum number of retransmissions, k is retransmission iteration, p is collision probability, CWₘᵢₙ is minimum contention window, Tₛ is successful transmission time, T_{c} is retransmission time due to a packet collision, Tₛₗₒₜ is slot time, Tcca is a clear channel assessment (CCA) busy time for a target station, Tro is radio on time, and TXop is time duration for which a station can send frames after it has gained contention.

Equation 2 approximates Equation 1. The collision probability, p, is determined by

$$p = 1 - \frac{N s}{{N}_{T}} ,$$

where N_{T} and N_{S} respectively defines the number of attempted and successful packet transmissions achieved by a target station. Equations 1 and 2 show that a new mean latency metric which may be used in the queueing discipline mechanisms is a function of p, CWₘᵢₙ, and T_{CCA} for given Tₛ, T_{c}, Tₛₗₒₜ, CWₘᵢₙ, TXop, Tᵣₒ, i.e.,

E[T]=ftn(p,CWₘᵢₙ,T_{CCA},TXop). Equation 3

Hereinafter, mean latency of the EDCA will be described in accordance with several embodiments.

For a particular AC, the average latency may be given by Equation 4.

$$E [ T [ AC ] ] = \frac{1 - p}{1 - {p}^{K [ AC ] + 1}} {\sum }_{k = 0}^{K [ AC ]} {p}^{k} ( \begin{matrix}{T}_{s} + {kT}_{c} + \\ \begin{matrix}\frac{{T}_{slot} C {W}_{min} [ AC ]}{2} ( {2}^{k + 1} - 1 ) + \\ TXop [ AC ] ( \frac{1}{1 - \frac{Tcca}{Tro}} - 1 )\end{matrix}\end{matrix} ) , = ftn ( p , C {W}_{min} [ AC ] , K [ AC ] , Tcca , TXop [ AC ] ) , E [ T [ AC ] ] \approx {T}_{s} + \frac{p}{( 1 - p )} {T}_{c} + \frac{{T}_{slot} C {W}_{min} [ AC ]}{2 ( 1 - {p}^{K [ AC ] + 1} ) ( 1 - 2 p )} ( i - 64 {p}^{6} ) + TXop [ AC ] ( \frac{{T}_{CCA}}{{T}_{ro} - {T}_{CCA}} ) , \qquad Equation 4$$

where K[AC] is the maximum number of retransmissions, which is determined by CWₘᵢₙ[AC] and CWₘₐₓ[AC], for a particular AC. Thus, some embodiments can use either E[T] or E[T[AC]] depending on the MAC.

Without loss of generality, some embodiments may use either E[T] or E[T[AC]] without distinction. Thus, when E[T] is used, this means that either DCF or EDCA at a particular AC is used as the MLO-MAC.

Some embodiments may develop MAC disciplines or training mechanisms of the packet queue for MLDs over two and more than two different rate channels for several reasons including to meet the worst-case packet delay or latency constraint. Another reason may be to reduce the power consumption due to the use of MLO, which may be critical for mobile devices. Yet another reason may be to develop a switching mechanism between different combinations of channels established by MLO to reduce the power consumption by MLO within the maximum latency constraint.

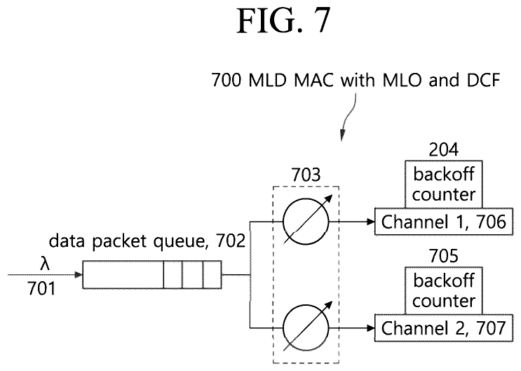

Hereinafter, queueing model with two heterogeneous channels for queueing discipline mechanisms by the MLO-MAC will be described with reference to FIG. 7.

FIG. 7 illustrates a block diagram of MLD-MAC with MLO and DCF in accordance with an embodiment. In particular, FIG. 7 illustrates MLDs that operate on two channels, 706 and 707, connected by a single unlimited packet queue, 702, for the MLO-MAC, 700. The MLDs support an asynchronous simultaneous STR. Since the considered channels, 706 and 707, have different rates for transmissions, different service times may be had for a packet, i.e., E[S[1]]≠E[S[2]], where E[x] denotes the statistical average for a particular parameter x. E[S[1]] and E[S[2]] are mean service time for the first channel and second channel, respectively.

The mean service time is proportional to the mean latency, defined by Equations 1 and 2. Also, without loss of generality, the first channel, 706, supports a faster rate in the higher frequency than the second channel, 707, so that E[S[1]]≠E[S[2]]→E[T[1]]≠E[T[2]] and E[T[1]]<E[T[2]], that is, μ[1]>μ[2], where μ[1] and μ[2] respectively define the service rates, i.e., successful packet delivery rate to the destination, over the first and second channels.

In some embodiments, a model may be more realistic for wireless communication networks that employ MLO, where the established links are characterized by different rates and capacities. Thus, models in accordance with several embodiments may be different from existing models that assume homogeneous channels, in which service rates or transmission rates are the same for all the channels established by MLO. In some embodiments, the training and discipline mechanisms for the MLD-MAC may be developed considering homogeneity in channels for MLO.

In some embodiments, operations such as transmissions and receptions of signals in the higher frequency may require a higher power consumption in average due to a higher path loss, so that PO[1]>PO[2]≡PO(fastrate channel)>PO(slow rate channel). Since the heterogeneous channel environment is more natural to MLO, an effective training and discipline for the MLO-MAC to schedule the packet queue, 702, is necessary by the block, 703, in transmissions and receptions over two available channels, 706 and 707. Thus, a packet waiting at the head of the queue should be effectively scheduled for transmissions and receptions to minimize the mean latency while minimizing the power consumption over a set of heterogeneous channels. A packet is generated from the upper layer, at a rate of λ packets per slot, 701, defined by Tₛₗₒₜ time interval, 709, and then arrives at the MLD packet data queue, 702.

In some embodiments, owing to the use of MLO, the MLO-MAC may allow multiple backoff counters, 704 and 705, over an individual channel, 702, for a packet transmission where each link independently maintains and updates contention parameters. Also, the MLO-MAC may flush the waiting packets in the packet data queue as soon as any of the channels are available, 706 and 707. That is, the selected channel may be determined by the following Equation 5.

$$\hat{l} = arg {min}_{l} min ( backoff counter [ l ] , channel utilization [ l ] ) , \qquad Equation 5$$

In Equation 5, backoff counter[l], is the backoff counter of the lth channel, and channel utilization[l] is the channel utilization of the lth channel. However, whenever there is a packet in the packet data queue, contention may still occur.

In some embodiments, one of the recognitions in reducing the mean latency by the MLO-MAC is related with how to discipline a packet data queue, namely, how to select a transmission channel for a packet waiting at the head of the queue. In some embodiments, a service discipline or training scheme, 703, is to choose one of the two idle channels at random when both channels are idle. When only one channel is idle, an incoming packet may use it for the transmissions and receptions without considering whether it is a fast or slow channel. Although this service discipline is simple, it may not be effective in reducing the mean latency due to an equal chance of using the slow channel. However, since the MLO-MAC has a priori knowledge about the rate of each channel and differences between the channels, it may be necessary to consider this priori information in developing the queue discipline and training schemes.

In some embodiments, a queue service discipline and training scheme, 703, is to choose the fast channel when both channels are in idle. Only when the slow channel is in idle, it is used for the transmissions according to the MLO-MAC. This service discipline may be more effective than the random discipline in reducing the latency.

Hereinafter, β-discipline will be described in accordance with several embodiments.

To deal with these two extreme service disciplines, some embodiments in accordance with this disclosure may use a β-discipline, 703, that is, when the fast and slow channels are in idle, the MLD-MAC selects the fast channel at probability β, with 0.5≤β≤1. Owing to MLO, only when the slow channel is in idle, that is, its backoff counter reaches zero while the backoff counter of the fast channel does not reach zero, 706, the MLD-MAC may select the slow channel for the transmissions. Thus, β-discipline is summarized as follows:

MLD-MAC may select the fast channel, 706, at probability β when both channels, 706 and 707, are in idle.

MLD-MAC may select the slow channel, 707, only when the slow channel is in idle while the fast channel, 706, is in busy for transmissions and receptions.

MLD-MAC may immediately select the finished fast or slow channel when either channel finished its transmissions, for a packet waiting at the head of the data packet queue, 702.

An arriving packet may wait in the data packet queue, 702, when both the channels, 706 and 707, are busy (e.g., for the transmissions or receptions).

Based on the β-discipline, CWₘᵢₙ will be decreased by one plus an additional number of idle or available channels, based on Equation 7.

$$C {W}_{min} ( β , MLO ) = \frac{C {W}_{min}}{2 + 1} {P}_{( 0 , 0 )} + \frac{C {W}_{min}}{2} {P}_{( 0 , 1 )} + \frac{C {W}_{min}}{2} {P}_{( 1 , 0 )} = γ C {W}_{min} , \qquad Equation 7$$

$$= \frac{C {W}_{min}}{2 + 1} {\tilde{P}}_{( 2 : 0 )} + \frac{C {W}_{min}}{2} {\tilde{P}}_{( 2 : 1 )} , \qquad Equation 8$$

where γ≤1, and P_{(0,0)} is the probability that both the channels, 706 and 707, are in idle, whereas P_{(0,1)} and P_{(1,0)} respectively denote probabilities that either the fast channel, 706, or slow channel, 707, is in idle. Equation 8 is an alternative expression for equation 7, where \tilde{P}_{(2:0)}=P_{(0,0)} and \tilde{P}_{(2:1)}≡P_{(0,1)}+P_{(1,0)}, in such a way that \tilde{P}_{(i:k)} denotes the probability that k channels are idle out of i available channels established by MLO.

The mean latency with β-discipline is given by the following Equation:

E[T(β)]=ftn(p(β,MLO),CWₘᵢₙ(β,MLO),T_{CCA}(β,MLO),TXop(β,MLO)). Equation 9

In Equation 9, p(β, MLO) may denote a collision probability with the β-discipline for MLO, CWₘᵢₙ(β, MLO) may denote a minimum contention window with the β-discipline for MLO, T_{CCA}(β, MLO) may denote a busy time for a target station with the β-discipline for MLO, and TXop(β, MLO) may denote a time duration for which a station can send frames after it has gained contention with the β-discipline for MLO.

As β approaches one, E[T(β)] becomes smaller since CWₘᵢₙ(β, MLO) decreases compared with CWₘᵢₙ for non-MLO. However, since the MLO deployment over two heterogeneous channels, 706 and 707, may require a greater power consumption due to the use of both channels asynchronously and the use of the fast channel, 706, operating in the higher frequency band, it may not be effective since it results in more power consumptions. Thus, it may be necessary to determine β optimally that minimizes the mean latency and power consumptions.

In some embodiments, for the notation purpose, Pr([i]) and Pr(A, [i]) may be used for probabilities of the selection for the ith channel by the non-MLO MAC and a type A queue discipline and training by the MLO-MAC. Also, E[T([i])], E[T(A, [i, j])], PO([i]), and PO(A, [i]) follow the similar notation for the mean latency and power consumption. E[T([i])] denotes a mean latency with non-MLO-MAC that uses only channel k, E[T(A, [i, j])] denotes a mean latency with a type A queue discipline that uses channels i and j established by the MLO-MAC, PO([i]) denotes power consumption with non-MLO-MAC that uses only channel k, and PO(A, [i]) denotes power consumption with a type A queue discipline that uses channel i established by the MLO-MAC.

Similarly, Cost(A, [i, j]/[k]) denotes a joint cost function with a type A queue discipline that uses channels i and j established by the MLO-MAC compared with non-MLO-MAC that uses only channel k.

For β-discipline in accordance with some embodiments, a joint cost function for the optimization is given by the following Equation 10:

$$Cost ( β , [ 1 , 2 ] / [ 1 ] ) = \frac{E [ T ( β , [ 1 , 2 ] ) ]}{E [ T ( [ 1 ] ) ]} + \frac{( PO ( β , [ 1 ] ) Pr ( β , [ 1 ] ) + PO ( β , [ 2 ] ) ( Pr ( β , [ 2 ] ) )}{PO ( [ 1 ] )} , \qquad Equation 10$$

In Equation 10, Pr(β, [1]) and Pr(β, [2]) for the β-discipline, obtained from the queueing model, are the probabilities that the first fast channel or second slow channel is chosen for the transmissions by the MLO-MAC. Furthermore, E[T([1])] and PO([1]) are the average latency and power consumption made by non-MLO that accesses only the first fast channel.

In some embodiments, the joint cost expressed by Equation 10 may be defined by sum of i) the ratio of the mean latency E[T(β, [1,2])] with the β-discipline that uses channels i and j established by the MLO-MAC to the mean latency E[T([1])] with non-MLO-MAC that uses only the fast channel 1 and ii) the power consumption (PO(β, [1])Pr(β, [1])+PO(β, [2])(Pr(β, [2])) with the βP-discipline that uses channels i and j established by the MLO-MAC to the power consumption PO([1]) with non-MLO-MAC that uses only the fast channel 1. The mean latency with the β-discipline is decreased and power consumption with the β-discipline is increased with respect to the non-MLO discipline and training that use only the fast channel. Then, the proposed β-discipline may be designed by determining β that jointly minimizes the mean latency increase while minimizing the increase of power consumptions made by the MLO. Thus, the β-discipline may be summarized as described below.

In summary, MLD-MAC may select the fast channel, 706, at probability β when both channels, 706 and 707, are in idle.

MLD-MAC may select the slow channel, 707, only when the slow channel is in idle while the fast channel, 706, is in busy for transmissions and receptions.

MLD-MAC may immediately select the finished fast or slow channel when either channel finished its transmissions, for a packet waited at the head of the data packet queue, 702.

An arriving packet may wait in the data packet queue, 702, when both the channels, 706 and 707, are in busy for the transmissions and receptions.

The optimal β may be computed by minimizing the joint cost function for the β-discipline.

Hereinafter, K-discipline in accordance with several embodiments will be described.

In some embodiments, the objective of a discipline and training of the MLO-MAC is to reduce the waiting time of the data packet in the queue and service time of MLO by using the slow channel. However, the fast channel may become idle after a short service time than the slow channel and can finish the services of the packets before finishing the services over the slow channel. Thus, the K-discipline may be developed in accordance with several embodiments. In the K-discipline in accordance with several embodiments, the slow channel may defer to its service opportunity until K packets are waiting in the data packet queue. Before K packets are accumulated in the packet queue, 702, only the fast channel, 706, can be used for the services, while the slow channel is in idle. That is, the slow channel, 707, is used only when the fast channel is busy for the service and the number of accumulated packets in the data queue, 702, is greater than K.

In some embodiments, the K-discipline and training scheme may be effective when the ratio of the rate of the slow channel to that of the fast channel is relatively big, since the MLO-MAC can be benefit from MLO by finishing fast services as much as possible.

The K-discipline in accordance with several embodiments may proceed as follows. MLD-MAC may use only the fast channel, 706, until K packets' accumulation in the packet queue, 702.

MLD-MAC may use both the fast, 706, and slow channels, 707, after recognizing K waiting packets in the packet queue, 702.

For the K-discipline, a similar mean delay metric, expressed by eq. (3) can be used. Therefore, the mean latency with K-discipline is given by the following Equation 11.

E[T(K,[1,2])]=ftn(p(K,MLO),CWₘᵢₙ(K,MLO),T_{CCA}(K,MLO),TXop(K,MLO)), Equation 11

In Equation 11, p(K, MLO) may denote a collision probability with the K-discipline for MLO, CWₘᵢₙ(K, MLO) may denote a minimum contention window with the K-discipline for MLO, T_{CCA}(K, MLO) may denote a busy time for a target station with the K-discipline for MLO, and TXop(K, MLO) may denote a time duration for which a station can send frames after it has gained contention with the K-discipline for MLO.

For the computation CWₘᵢₙ(K, MLO), different P_{(0,0)},P_{(0,1)} may be used and P_{(1,0)} for the K-discipline. In addition, p(K, MLO) and T_{CCA}(K, MLO) should be related with CWₘᵢₙ(K, MLO). Since the K-discipline tries to use the fast channel, 706, as much as possible, the power consumption may be greater than that of the β-discipline. Thus, it is important to find the optimal K that minimizes the mean latency and power consumptions.

Similar to eq. (10), a joint cost for the optimization is given by Equation 12.

$$Cost ( K , [ 1 , 2 ] / [ 1 ] ) = \frac{E [ T ( K , [ 1 , 2 ] ) ]}{E [ T ( [ 1 ] ) ]} + \frac{( PO ( K , [ 1 ] ) Pr ( K , [ 1 ] ) + PO ( K , [ 2 ] ) ( Pr ( K , [ 2 ] ) )}{PO ( [ 1 ] )} . \qquad Equation 12$$

In Equation 12, Pr(K, [1]) and Pr(K, [2]) for the K-discipline, obtained from the queueing model, are the probabilities that the first fast channel or second slow channel is chosen for the transmissions by the MLO-MAC. Furthermore, E[T([1])] and PO([1]) are the average latency and power consumption made by non-MLO that accesses only the first fast channel.

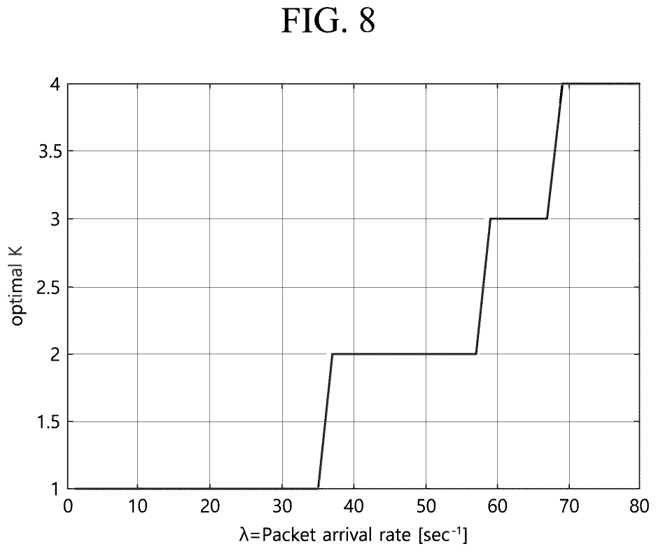

In some embodiments, the joint cost expressed by Equation 12 may be defined by sum of i) the ratio of the mean latency E[T(K, [1,2])] with the K-discipline that uses channels i and j established by the MLO-MAC to the mean latency E[T([1])] with non-MLO-MAC that uses only the fast channel 1 and ii) the power consumption (PO(K, [1])Pr(K, [1])+PO(K, [2])(Pr(K, [2])) with the K-discipline that uses channels i and j established by the MLO-MAC to the power consumption PO([1]) with non-MLO-MAC that uses only the fast channel 1. By minimizing the Cost(K, [1,2]/[1]), the optimal K can be obtained for the K-discipline. This optimal K may depend on the arrival packet rate, so that K value should be adaptively determined. In general, as the arrival rate, 702, increases, a greater K should be used to minimize the number of waiting and serving packets in the system as shown in FIG. 8 in accordance with an embodiment, which is also related with minimizing the cost function. In particular, FIG. 8 illustrates an example of an optimal K depending on the arrival rate in accordance with an embodiment. Thus, the K-discipline is summarized as described below.

In summary, MLD-MAC may use only the fast channel until K packets' accumulation in the packet queue.

MLD-MAC may use both the fast and slow channels after recognizing K waiting packets in the packet queue.

The optimal K may be computed by minimizing the joint cost function for the K-discipline.

Some embodiments may include static split of traffic across multiple links. In some embodiments, arriving packets or packet arrivals may refer to data generated by applications running on the devices and sent down to the MLO-MAC layer for transmission.

In some embodiments, allocating a packet to a channel or to a server may refer to putting the packet in a real or virtual queue associated with a channel. When MAC layer acquires a transmission opportunity on a channel (e.g., by following channel contention rules), it may transmit one or more packets from the queue associated with the channel (e.g., according to FCFS rule).

In some embodiments, putting a packet in MLO-MAC queue may refer to holding the packet in a general queue not associated with a specific channel. Packets from MLO-MAC queue may later be allocated to a specific channel (e.g., put in a real or virtual queue associated with a channel).

Service disciplines as described herein in accordance with several embodiments, namely β-discipline and K-discipline, which may allocate an arriving packet to a channel (e.g., a queue associated with the channel) based on the state of the system (e.g., the number of packets allocated to each channel's queue). Some embodiments may include a static-split service discipline that allocates arriving packets to the channels irrespective of the current state of the queues.

More specifically, associated with each MLO channel may be a probability of allocation (e.g., such that the sum of probability of allocation across all MLO channels may be unity). An arriving packet may be allocated to a channel according to the probabilities of allocation.

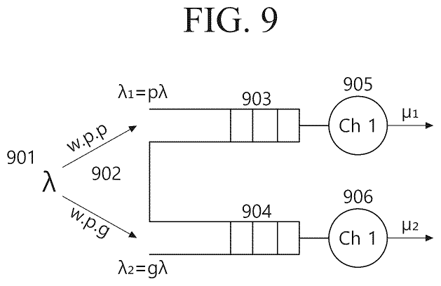

FIG. 9 illustrates static split discipline applied to MLO comprising two channels in accordance with an embodiment. Probabilities of allocation 902 of the two channels are denoted by p and q (where p≥0, q≥0, and p+q=1). An arriving packet may be allocated with probability p to the queue 903 associated with the first channel 905, whereas it may be allocated with probability q=1−p to the queue 904 associated with the second channel 906. Therefore, by allocating arrivals in such a manner may result in splitting the overall arrival intensity of λ into a fraction λ₁=p·λ allocated to the first channel 905 and the remaining fraction λ₂=q·λ allocated to the second channel 906.

In some embodiments, for the static split service discipline, the probabilities of allocation may be chosen to optimize the performance of the system, e.g., various latency statistics, among others.

In some embodiments, a service discipline controller module may be configured with a threshold such that, if an estimated traffic load is smaller than the threshold, then probability of allocation of the fastest channel is unity. For example, all arriving packets may be allocated to the fastest channel. If an estimated traffic load is larger than the threshold, then at least a fraction of load not less than the threshold may be allocated to the fastest channel.

In some embodiments, when probability of allocation of the fastest channel is unity (i.e., all arriving packets are allocated to the fastest channel), then MLD may operate in more power-efficient single-radio or single-band mode. For example, by putting a radio associated with the slower channel to sleep or turning it off. In some embodiments, the estimated traffic load may be based on an estimate of packet arrival intensity.

In some embodiments, the threshold may depend on an estimated capacity of each channel. For example, for the MLO system depicted in FIG. 9, under the assumption of Poisson arrivals, exponentially distributed packet sizes, and channels with rates μ₁ and μ₂ packets per unit time respectively, it can be shown that the expected packet sojourn time in the system is parameterized by probability of allocation p as provided by Equation 13.

$$E [ T ( p ) ] = \frac{p}{{μ}_{1} - p λ} + \frac{1 - p}{{μ}_{2} - ( 1 - p ) λ} . \qquad Equation 13$$

Further suppose, without loss of generality, that the first channel is faster, i.e., μ₁≥μ₂. Then it can be shown that, the threshold Amin given below by Equation 14 minimizes the expected sojourn time E[T(p)].

$${λ}_{min} = {μ}_{1} - \sqrt{{μ}_{1} \cdot {μ}_{2}} . \qquad Equation 14$$

In particular, if arrival intensity is smaller than this threshold (i.e., λ≤λₘᵢₙ), then probability of allocation of the faster channel should be unity (i.e., p=1).

More generally, if arrival intensity is greater than this threshold, i.e., λ>λₘᵢₙ, then probability of allocation to the fastest channel is such that fraction of arrival intensity allocated to the fastest server at least λₘᵢₙ. E.g., it can be shown that, in order to minimize expected sojourn time E[T(p)], the probability of allocation to fastest channel p must satisfy Equation 15.

$$p \cdot λ = {λ}_{min} + \frac{\sqrt{{μ}_{1}}}{\sqrt{{μ}_{1}} + \sqrt{{μ}_{2}}} \cdot ( λ - {λ}_{min} ) . \qquad Equation 15$$

In particular, the fastest channel should be allocated at least Amin arrival intensity, and the remaining arrival intensity (λ−λₘᵢₙ) should be divided between the channels proportional to square-root of their capacity \sqrt{uᵢ}.

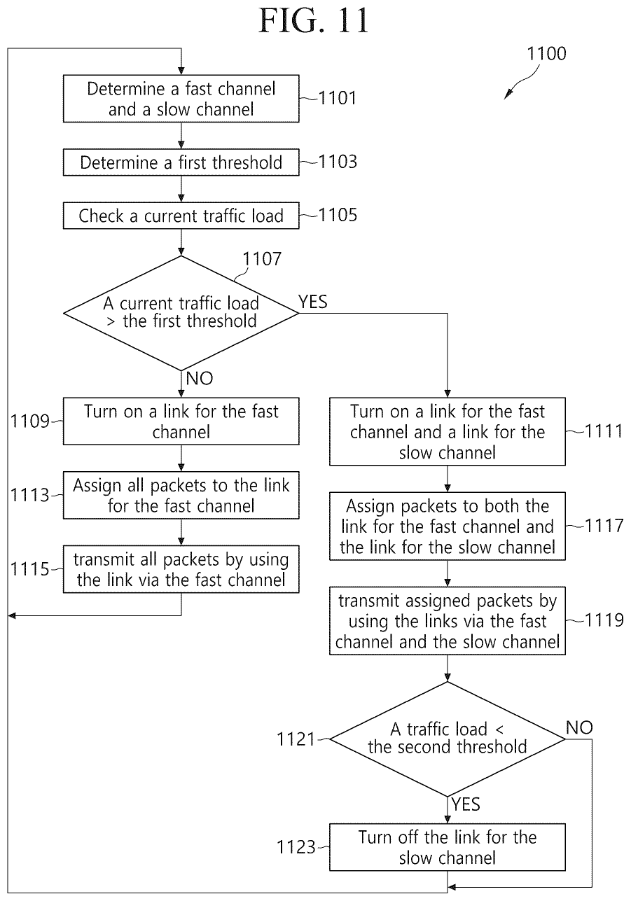

FIG. 11 illustrates a flow chart of an example process of configuring MLO using a load threshold in accordance with an embodiment.

The process 1100, in operation 1101, determines a fast channel and a slow channel.

In operation 1103, the process determines a first threshold. In some embodiments, the threshold may depend on an estimated capacity or rate of each link. In certain embodiments, the threshold may depend on an estimated power consumption of each link. In certain embodiments, other statistics such as the mean latency and the optimized β that minimizes the joint cost function can be used to determine the threshold.

In operation 1105, the process checks a current traffic load.

In operation 1107, the process determines whether the current traffic load is greater than the first threshold.

If in operation 1107, the process determines that the current traffic load is greater than the first threshold, the process proceeds to operation 1109 where the process turns on a link for the fast channel.

In operation 1113, the process assigns all packets to the link for the fast channel.

In operation 1115, the process transmits all packets using the link via the fast channel, and returns to operation 1101.

If in operation 1107, if the current traffic load is greater than the first threshold, the process proceeds to operation 1111 where the process turns on a link for the fast channel and a link for the slow channel.

In operation 1117, the process assigns packets to both the link for the fast channel and the link for the slow channel. In some embodiments, at least a minimum load is allocated to the fast channel. In some embodiments, the minimum load may be the same as the threshold or another configured value.

In operation 1119, the process transmits assigned packets by using the links via the fast channel and the slow channel.

In operation 1121, the process determines whether a traffic load is less than the second threshold.

If in operation 1121, the process determines that the traffic load is not less than the second threshold, the process returns to operation 1101.

If in operation 1121, the process determines that the traffic load is less than the second threshold, the process proceeds to operation 1123 where the process turns off the link for the slow channel and returns to operation 1101.

In some embodiments, fixed hysteresis values of the first threshold and the second threshold may be used to turn off the first fast and second slow link. In some embodiments, the second threshold is the same as the first threshold.

In some embodiments, the MLO controller may be configured with a countdown timer, where the MLO controller waits for the timer to expire (e.g., reach 0) before turning off the link. In some embodiments, the timer is reset (i.e., a preconfigured value is loaded in the countdown timer) based on the estimated traffic load, e.g., when the traffic load drops below the second threshold. In some embodiments, the timer is paused if the estimated traffic load exceeds a threshold (e.g., the first threshold). In some embodiments, the estimated traffic load may depend on an estimated of packet arrival intensity.

In some embodiments, an MLO controller may be configured with a packet threshold where the MLO controller turns on an additional link when data packets associated with one or more currently on channels exceeds the threshold.

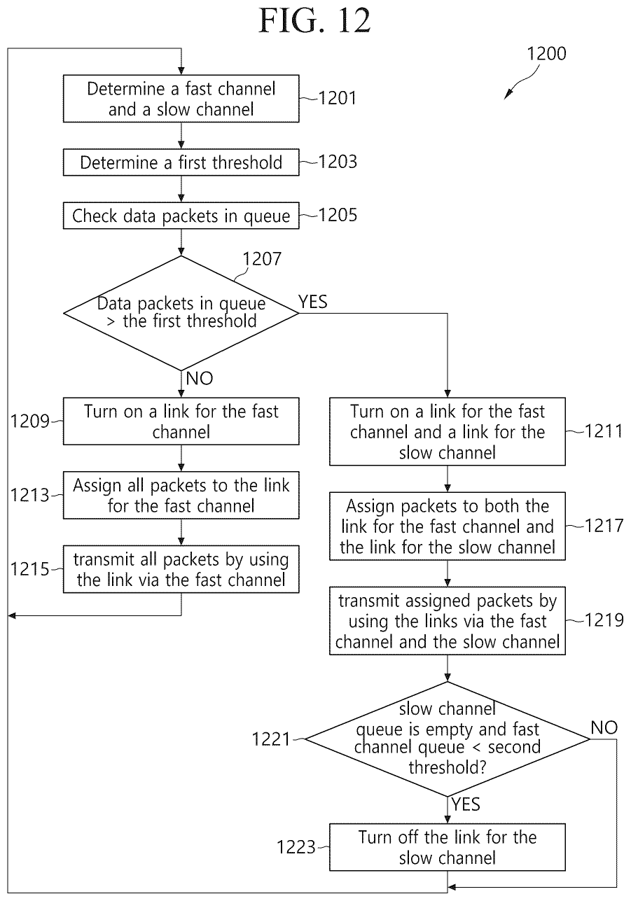

FIG. 12 illustrates a flow chart of an example process of configuring MLO using a packet threshold in accordance with an embodiment.

The MLD 1200, in operation 1201, determines a fast channel and a slow channel.

In operation 1203, the process determines a first threshold. In some embodiments, the threshold may be in terms of total data (e.g., in bits) or total number of packets. In certain embodiments, the threshold may depend on an estimated capacity of each link. In certain embodiments, the threshold may depend on an estimated power consumption of each link. In certain embodiments, other statistics such as such as the mean latency and the optimized K that minimizes the joint cost function can be used to determine the threshold.

In operation 1205, the process checks data packets in a queue.

In operation 1207, the process determines whether the number of data packets in the queue is greater than the first threshold.

If in operation 1207, the process determines that the number of data packets in queue is not greater than the first threshold, the process proceeds to operation 1209.

In operation 1209, the process turns on a link for the first channel.

In operation 1213, the process assigns all packets to the link for the fast channel.

In operation 1215, the process transmits all packets using the link via the fast channel, and returns to operation 1201.

If in operation 1207, if the process determines that the number of data packets in queue is greater than the first threshold, the process proceeds to operation 1211 where the process turns on a link for the fast channel and a link for the slow channel.

In operation 1217, the process assigns packets to both the link for the fast channel and the link for the slow channel.

In operation 1219, the process transmits assigned packets by using the links via the fast channel and the slow channel.

In operation 1221, the process determines whether a queue associated with the slow channel is empty and the number of data packets in a queue associated with the fast channel is less than the second threshold.

If in operation 1221, the process determines that a queue associated with the slow channel is empty and the number of data packets in a queue associated with the fast channel is less than the second threshold, the process proceeds to operation 1223 where the process turns off the link for the slow channel. In some embodiments, fixed hysteresis values of the first and the second thresholds may be used to turn off the first fast and the second slow link. In certain embodiments, the second threshold may be the same as the first threshold. In some embodiments, a countdown timer may be used where the MLO controller waits for the timer to expire (e.g., reach 0) before turning off the link. In certain embodiments, the timer is reset (i.e., a preconfigured value is loaded in the countdown timer) based on at least one queue associated with a link when the queue associated with the slow channel is empty and the queue associated with the fast channel is drops below the second threshold. In some embodiments, if the timer is running, then the timer is paused if the queues-depended conditions (e.g., when the queue associated with the slow channel is empty and the queue associated with the fast channel is drops below the second threshold) stop holding true.

If in operation 1121, the process determines that a queue associated with the slow channel is not empty or that the number of data packets in a queue associated with the fast channel is not less than the second threshold, the process returns to operation 1201.

Hereinafter, as the first use case, without knowledge of the number of interfering stations in the network, EDCA-based queue discipline and train mechanisms will be described in accordance with several embodiments.

In some embodiments, the queue discipline and train mechanisms may be based on recognition that the joint optimization is related with the enhanced distributed channel access (EDCA), in such a way that the mean latency should be expressed by the parameters of EDCA, such as the maximum number of retransmissions, collision probability, minimum contention window, CCA busy time for a target MLD, and TXop, a time duration for which a target MLD can send frames after it has gained contention. Without knowledge of the number of interfering stations in the network, a new mean latency may be developed and employed for the optimization in determining the following:
(i) the load threshold where the MLO controller turns on an additional link when an estimated traffic load exceeds the threshold;
(ii) and the load threshold where the MLO controller turns on an additional link when data packets associated with one or more currently on channels exceeds the threshold by the β-discipline and K-discipline over two heterogeneous channels.

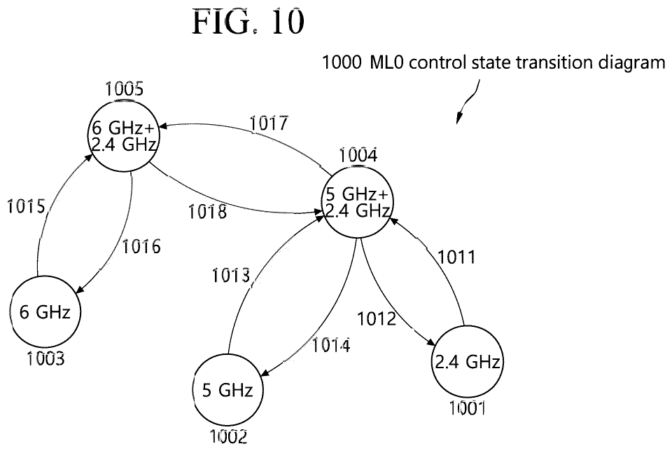

Hereinafter, as the second use case, a switching mechanism between different combinations of channels established by MLO in accordance with an embodiment will be described with reference to FIG. 10.

FIG. 10 illustrates an example of MLO control state diagram in accordance with an embodiment. In FIG. 10, MLO, 1000, establishes the multi-link using three channels servicing at different frequency bands with an accompanying bandwidth.

Channel 1: 6 GHz with 160 MHz bandwidth, with E[T([1])] and PO([1]), 1003.

Channel 2: 5 GHz with 80 MHz bandwidth, with E[T([2])] and PO([2]), 1002.

Channel 3: 2.4 GHz with 20 MHz bandwidth, with E[T([3])] and PO([3]), 1001.

In general, it is recognized that E[T([1])]≤E[T([2])]≤E[T([3])] and PO([1])≥PO([2])≥PO([3]).

Hereinafter, a queue discipline and training for the switching from 2.4 GHz to (5+2.4 GHz) in accordance with several embodiments will be described.

For the state transition, 1011, the cost functions for the β and K disciplines are respectively given by Equation 16.

$$Cost ( β , \frac{[ 2 , 3 ]}{[ 2 ]} ) = \frac{E [ T ( β , [ 2 , 3 ] ) ]}{E [ T ( [ 2 ] ) ]} + \frac{( PO ( β , [ 2 ] ) Pr ( β , [ 2 ] ) + PO ( β , [ 3 ] ) ( Pr ( β , [ 3 ] ) )}{PO ( [ 2 ] )} , \qquad Equation 16$$

$$Cost ( K , [ 2 , 3 ] / [ 2 ] ) = \frac{E [ T ( K , [ 2 , 3 ] ) ]}{E [ T ( [ 2 ] ) ]} + \frac{( PO ( K , [ 2 ] ) Pr ( K , [ 2 ] ) + PO ( K , [ 3 ] ) ( Pr ( K , [ 3 ] ) )}{PO ( [ 2 ] )} .$$

The optimal β and K values are obtained by minimizing Cost(β), [2,3]/[2]) and Cost(K, [2,3]/[2]).

When the MLD finishes servicing a packet by MLO, the queue discipline switches to the non-MLO and power saving mode, that is, MLO is controlled to use mainly channel 3, 1012. Similar transitions 1013 and 1015 follow the same way as that of 1011 with modified cost functions. Similar to transition 1012, transitions 1014 and 1016 follow the same way as that of transition 1012, that is, switching to the power saving modes or states, 1002 and 1003.

Hereinafter, a queue discipline and training for the switching from (5+2.4 GHz) to (6+2.4 GHz) in accordance with several embodiments will be described.

For the state transition, 1017, the cost functions for the β and K disciplines are given by Equation 17.

$$Cost ( β * , \frac{[ 1 , 3 ]}{[ 2 , 3 ]} ) = \frac{E [ T ( β , [ 1 , 3 ] ) ]}{E [ T ( β , [ 2 , 3 ] ) ]} + \frac{( PO ( β , [ 1 ] ) Pr ( β , [ 3 ] ) + PO ( β , [ 3 ] ) ( Pr ( β , [ 3 ] ) )}{( PO ( β , [ 2 ] ) Pr ( β , [ 2 ] ) + PO ( β , [ 3 ] ) ( Pr ( β , [ 3 ] ) )} ,$$

$$Cost ( K * , [ 1 , 3 ] / [ 2 , 3 ] ) = \frac{E [ T ( K , [ 1 , 3 ] ) ]}{E [ T ( K , [ 2 , 3 ] ) ]} + \frac{( PO ( K , [ 1 ] ) Pr ( K , [ 3 ] ) + PO ( K , [ 3 ] ) ( Pr ( K , [ 3 ] ) )}{( PO ( K , [ 2 ] ) Pr ( K , [ 2 ] ) + PO ( K , [ 3 ] ) ( Pr ( K , [ 3 ] ) )} ,$$

where Cost(x*, [i, j]/[k, l]) denotes a joint cost function with type x queue discipline that uses channels i and j by the MLO-MAC compared with MLO-MAC that uses k and 1 channels under the condition that channels, i, j, k, l are established by MLO.

The optimal β and K values may be obtained by minimizing Cost(β*, [1,3]/[2,3]) and Cost(K*, [1,3]/[2,3]). When the MLD finishes delivering a packet by MLO, the queue discipline switches to the MLO and power saving mode, that is, mainly uses channel 2 and channel 3, transition 1018. Furthermore, when it not necessary to use MLO, the queue discipline switches to the non-MLO and the best power saving mode, a transition 1012 or transition 1014, that is, mainly uses either channel 2 or channel 3. However, it may be preferable to take a transition 1012 in terms of power consumption.

Hereinafter, as the third use case, β-discipline and K-discipline for three heterogeneous channels in accordance with several embodiments will be described.

In some embodiments, as one exemplary extension from the two heterogeneous channels, MLO can establish three channels with different mean service times as E[S[1]]≠E[S[2]]≠E[S[3]] and E[S[1]]<E[S[2]]<E[S[3]], as provided by Equations 18A and 18B.

$$C {W}_{min} ( β , MLO , [ 1 , 2 , 3 ] ) = \frac{C {W}_{min}}{3 + 1} {P}_{( 0 , 0 , 0 )} + \frac{C {W}_{min}}{2 + 1} {P}_{( 0 , 0 , 1 )} + \frac{C {W}_{min}}{2 + 1} {P}_{( 0 , 1 , 0 )} + \frac{C {W}_{min}}{1 + 1} {P}_{( 0 , 1 , 1 )} + \frac{C {W}_{min}}{2 + 1} {P}_{( 1 , 0 , 0 )} + \frac{C {W}_{min}}{1 + 1} {P}_{( 1 , 0 , 1 )} + \frac{C {W}_{min}}{1 + 1} {P}_{( 1 , 1 , 0 )} , \qquad Equation 18 A$$

$$= \frac{C {W}_{min}}{3 + 1} {\tilde{P}}_{( 30 )} + \frac{C {W}_{min}}{2 + 1} {\tilde{P}}_{( 3 : 1 )} + \frac{C {W}_{min}}{1 + 1} {\tilde{P}}_{( 32 )} , \qquad Equation 18 B$$

where P_{(0,0,0)}: the probability that three channels are in idle; P_{(0,0,1)}: the probability that channel 1 and channel 2 are in idle; P_{(0,1,0)}: the probability that channel 1 and channel 3 are in idle; P_{(0,1,1)}: the probability that channel 1 is in idle; P_{(1,0,0)}: the probability that channel 2 and channel 3 are in idle; P_{(1,0,1)}: the probability that channel 2 is in idle; and P_{(1,1,0)}: the probability that channel 3 is in idle. Based on equation 18A, T(β, MLO, [1,2,3]) can be computed for the use of three channels. Other alternative expressions can be obtained for different combinations of channels by MLO.

In addition, PO(β, [1,2,3]) is a power consumption for the use of three channels established by MLO. For other channel combinations, alternative expressions for power consumption can be obtained. Thus, a corresponding cost function may be developed, and the β-discipline and K-discipline may be applied to service a packet waiting at the head of the queue. In equation 18B, \tilde{P}_{(3:0)}=P_{(0,0,0)}, P_{(3:1)}≡P_{(0,0,1)}+P_{(0,1,0)}+P_{(1,0,0)}, \tilde{P}_{(3:2)}≡P_{(0,1,1)}+P_{(1,0,1)}+P_{(1,1,0)} with \tilde{P}_{(i:k)} denoting k available idle channels out of i available channels established by MLO.

Hereinafter, as the fourth use case 4, β-discipline and K-discipline for a general S heterogeneous channels in accordance with several embodiments will be described.

In some embodiments, for S heterogeneous channels, which is another exemplary extension from the two heterogeneous channels that support different rate or capacity, the β-discipline and K-discipline may be applied. Since MLO may need to establish more heterogeneous channels, minimizing the power consumption caused by MLO may be much more important. Referring to equations 8 and 18A, a corresponding CWₘᵢₙ(β, MLO, [1,2, . . . , S]) can be computed by Equation 19.

$$C {W}_{min} ( β , MLO , [ 1 , 2 , … , S ] ) = C {W}_{min} {\sum }_{l = 0}^{S - 1} \frac{1}{S - l + 1} {\tilde{P}}_{( S : l )} , \qquad Equation 19$$

In Equation 19, \tilde{P}_{(S:l)} may depend on a particular discipline needs to consider all possible combinations of idle channels whose summation is 1, Now based on equation 19, the mean latency E[T(β, [1,2, . . . , S])], and similarly, E[T(K, [1,2, . . . S])], can be computed. A joint cost function can be defined depending on a combination of channels, and then the optimal β for the β-discipline and optimal K for the K-discipline can be computed for a corresponding cost function.

Hereinafter, as the fifth use case 5, β-discipline and K-discipline to minimize the mean idle time of the slow channel and power consumption in accordance with several embodiments will be described.

In some embodiments, the β-discipline and K-discipline may be applied to minimize the mean idle time of the slow channel and power consumption. In some embodiments, traffic intensity may be considered, where, for example: ρ≥ρ_{c}, ρ_{c}=ftn(λ, μ₁, μ₂), ρ_{c}=0.4089.

In some embodiments, the objective may be to maximize throughput ratio. In particular, the ratio may be a ratio of throughput delivered by the slow link to the sum of throughputs delivered by both the slow and fast links. The constraints may include: i) minimize the mean idle time of the slow channel, which may mean a need to reduce the time portion of using the fast link to minimize the power consumption by MLO; and ii) minimize the mean power consumption made by both links. The following Equations 20 and 21 provides the optimization problem for linear programming for the β-discipline and K-discipline.

$${max}_{{β}_{1} ∈ R} \frac{T {P}_{β , 2}}{T {P}_{β , 1} + T {P}_{β , 2}} , \qquad Equation 20$$

$$s t {\overline{T}}_{β , I} ≡ T ( {P}_{( 0 , 00 )} + {P}_{( 0 , 10 )} ) < {T}_{{I}_{TH}} ,$$

$${\overline{W}}_{β} < L ,$$

$${EG}_{β} < E$$

In equation 20, TP_{β,i} is the throughput delivered by link i in the β-discipline.

For the K-discipline, as provided by Equation 21.

$${max}_{K ∈ I} \frac{T {P}_{k , 2}}{T {P}_{K , 1} + T {P}_{K , 2}} , \qquad Equation 21$$

$$s t {\overline{T}}_{K , I} ≡ T ( {P}_{( 0 , 00 )} + {\sum }_{K = 1}^{K - 1} {P}_{k , 00 )} ) < {T}_{{I}_{TH}} ,$$

$${\overline{W}}_{K} < L ,$$

$${EG}_{K} < E$$

In equation 21, TP_{k,i} is the throughput delivered by link i in the K-discipline.

Hereinafter, as the sixth use case 6, K-discipline for TXOP in accordance with several embodiments will be described.

In some embodiments, the K-discipline may be applied for transmit opportunity (TXOP). In particular, TXOP may provide a contention-free channel access for a period of time. The K-discipline may specify a controlled access period (CAP) that fills the queue with a series of incoming packets. In some embodiments, for TXOP, the K-discipline may assign packets in the queue on the fast link in such a way when the total number of packets in the system is smaller than K to provide contention-free channel access. When the number of packets in the queue is greater than K, both links may be served (contention channel access). In some embodiments, when the number of packets is smaller than K, the incoming packets are filled into the queue until it becomes K. The CAP may be determined by: K×E[S₁].

In some embodiments, the optimization problem can be defined as provided by Equation 22.

$${max}_{K ∈ I} C A P , C A P = K \times E [ {S}_{1} ] \qquad Equation 22$$

$$s t {\overline{W}}_{k} < L ,$$

$${EG}_{K} < E$$

FIG. 11 illustrates a flow chart of an example process of configuring MLO using a load threshold in accordance with an embodiment.

The process 1100, in operation 1101, determines a fast channel and a slow channel.

In operation 1103, the process determines a first threshold. In some embodiments, the threshold may depend on an estimated capacity or rate of each link. In certain embodiments, the threshold may depend on an estimated power consumption of each link. In certain embodiments, other statistics such as the mean latency and the optimized β that minimizes the joint cost function can be used to determine the threshold.

In operation 1105, the process checks a current traffic load.

In operation 1107, the process determines whether the current traffic load is greater than the first threshold.

If in operation 1107, the process determines that the current traffic load is greater than the first threshold, the process proceeds to operation 1109 where the process turns on a link for the fast channel.

In operation 1113, the process assigns all packets to the link for the fast channel.

In operation 1115, the process transmits all packets using the link via the fast channel, and returns to operation 1101.

If in operation 1107, if the current traffic load is greater than the first threshold, the process proceeds to operation 1111 where the process turns on a link for the fast channel and a link for the slow channel.

In operation 1117, the process assigns packets to both the link for the fast channel and the link for the slow channel. In some embodiments, at least a minimum load is allocated to the fast channel. In some embodiments, the minimum load may be the same as the threshold or another configured value.

In operation 1119, the process transmits assigned packets by using the links via the fast channel and the slow channel.

In operation 1121, the process determines whether a traffic load is less than the second threshold.

If in operation 1121, the process determines that the traffic load is not less than the second threshold, the process returns to operation 1101.

If in operation 1121, the process determines that the traffic load is less than the second threshold, the process proceeds to operation 1123 where the process turns off the link for the slow channel and returns to operation 1101.

In some embodiments, fixed hysteresis values of the first threshold and the second threshold may be used to turn off the first fast and second slow link. In some embodiments, the second threshold is the same as the first threshold.

In some embodiments, the MLO controller may be configured with a countdown timer, where the MLO controller waits for the timer to expire (e.g., reach 0) before turning off the link. In some embodiments, the timer is reset (i.e., a preconfigured value is loaded in the countdown timer) based on the estimated traffic load, e.g., when the traffic load drops below the second threshold. In some embodiments, the timer is paused if the estimated traffic load exceeds a threshold (e.g., the first threshold). In some embodiments, the estimated traffic load may depend on an estimated of packet arrival intensity.

In some embodiments, an MLO controller may be configured with a packet threshold where the MLO controller turns on an additional link when data packets associated with one or more currently on channels exceeds the threshold.

FIG. 12 illustrates a flow chart of an example process of configuring MLO using a packet threshold in accordance with an embodiment.

The MLD 1200, in operation 1201, determines a fast channel and a slow channel.

In operation 1203, the process determines a first threshold. In some embodiments, the threshold may be in terms of total data (e.g., in bits) or total number of packets. In certain embodiments, the threshold may depend on an estimated capacity of each link. In certain embodiments, the threshold may depend on an estimated power consumption of each link. In certain embodiments, other statistics such as such as the mean latency and the optimized K that minimizes the joint cost function can be used to determine the threshold.

In operation 1205, the process checks data packets in a queue.

In operation 1207, the process determines whether the number of data packets in the queue is greater than the first threshold.

If in operation 1207, the process determines that the number of data packets in queue is not greater than the first threshold, the process proceeds to operation 1209.

In operation 1209, the process turns on a link for the first channel.

In operation 1213, the process assigns all packets to the link for the fast channel.

In operation 1215, the process transmits all packets using the link via the fast channel, and returns to operation 1201.

If in operation 1207, if the process determines that the number of data packets in queue is greater than the first threshold, the process proceeds to operation 1211 where the process turns on a link for the fast channel and a link for the slow channel.

In operation 1217, the process assigns packets to both the link for the fast channel and the link for the slow channel.

In operation 1219, the process transmits assigned packets by using the links via the fast channel and the slow channel.

In operation 1221, the process determines whether a queue associated with the slow channel is empty and the number of data packets in a queue associated with the fast channel is less than the second threshold.

If in operation 1221, the process determines that a queue associated with the slow channel is empty and the number of data packets in a queue associated with the fast channel is less than the second threshold, the process proceeds to operation 1223 where the process turns off the link for the slow channel. In some embodiments, fixed hysteresis values of the first and the second thresholds may be used to turn off the first fast and the second slow link. In certain embodiments, the second threshold may be the same as the first threshold. In some embodiments, a countdown timer may be used where the MLO controller waits for the timer to expire (e.g., reach 0) before turning off the link. In certain embodiments, the timer is reset (i.e., a preconfigured value is loaded in the countdown timer) based on at least one queue associated with a link when the queue associated with the slow channel is empty and the queue associated with the fast channel is drops below the second threshold. In some embodiments, if the timer is running, then the timer is paused if the queues-depended conditions (e.g., when the queue associated with the slow channel is empty and the queue associated with the fast channel is drops below the second threshold) stop holding true.

If in operation 1221, the process determines that a queue associated with the slow channel is not empty or that the number of data packets in a queue associated with the fast channel is not less than the second threshold, the process returns to operation 1201.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method performed by an apparatus capable of multi-link operations with respect to a plurality of channels, comprising:
determining a fast channel and a slower channel;
transmitting a packet in a packet queue using the fast channel without using the slower channel when a number of data packets waiting in the packet queue is smaller than a first threshold number; and
transmitting a packet in the packet queue using both the fast channel and the slower channel when the number of data packets waiting in the packet queue is equal to or greater than the first threshold number.

2. The method of claim 1, wherein the first threshold number is determined based on a latency in a scheme that uses the fast channel and the slower channel and a power consumption in the scheme that uses the fast channel and the slower channel.

3. The method of claim 1, wherein the first threshold number is determined based on a rate at which packets arrive in the packet queue.

4. The method of claim 3, wherein the first threshold number is determined further based on services rates of the fast channel and the slower channel.

5. The method of claim 3, wherein if the rate at which packets arrive in the packet queue increases, the threshold is increased.

6. The method of claim 1, further comprising turning off the slower channel when a queue associated with the slower channel is empty and a queue associated with the fast channel drops below a second threshold number, the second threshold number being the same as or different than the first threshold number.

7. The method of claim 1, further comprising turning off the slower channel when a predetermined time passes.

8. A station (STA) in a wireless network, the STA comprising:
a memory;
a processor coupled to the memory, the processor configured to:
establish multi-link operation with respect to a plurality of channels including a fast channel and a slower channel;
transmit a packet in a packet queue using the fast channel without using the slower channel when a number of data packets waiting in the packet queue is smaller than a first threshold number; and
transmit a packet in the packet queue using both the fast channel and the slower channel when the number of data packets waiting in the packet queue is equal to or greater than the first threshold number.

9. The STA of claim 8, wherein the first threshold number is determined based on a latency in a scheme that uses the fast channel and the slower channel and a power consumption in the scheme that uses the fast channel and the slower channel.

10. The STA of claim 8, wherein the first threshold number is determined based on a rate at which packets arrive in the packet queue.

11. The STA of claim 10, wherein the first threshold number is determined further based on services rates of the fast channel and the slower channel.

12. The STA of claim 11, wherein if the rate at which packets arrive in the packet queue increases, the threshold is increased.

13. The STA of claim 8, wherein the processor is further configured to turn off the slower channel when a queue associated with the slower channel is empty and a queue associated with the fast channel drops below a second threshold number, the second threshold number being the same as or different than the first threshold number.

14. The STA of claim 8, wherein the processor is further configured to turn off the slower channel when a predetermined time passes.

15. A method performed by an apparatus capable of multi-link operations with respect to a plurality of channels, comprising:
determining a fast channel and a slower channel;
when the fast channel and slower channel are idle, selecting one of the fast channels and the slower channel for transmissions based on a probability;
when the slower channel is idle and the fast channel is busy, selecting the slower channel for transmissions; and
transmitting a data packet using the selected channel.

16. The method of claim 15, further comprising when one of the fast channels and the slower channel finishes a transmission, selecting the finished channel, for a data packet waiting at the head of a packet queue.

17. The method of claim 15, wherein an arriving packet waits in a packet queue when both the fast channel and the slower channel are busy.

18. The method of claim 15, wherein the probability is determined based on a latency in a first scheme that uses the fast channel and the slower channel and a power consumption in the first scheme that uses the fast channel and the slower channel.

19. The method of claim 18, wherein the probability is determined further based on a latency in a second scheme that does not use the slower channel and uses the fast channel and a power consumption in the second scheme.

20. The method of claim 18, wherein the latency in the first scheme is determined based on a collision probability, a minimum contention window, a CCA busy time, and a transmit opportunity (TXOP) duration in the first scheme.
